(19) United States
(12) Patent Application Publication
(10) Pub. No.: US 2025/0360034 A1
(43) Pub. Date: Nov. 27, 2025

(54) WALKING AID DEVICE

(71) Applicant: ZHEJIANG HFIZER MEDICAL EQUIPMENT CO., LTD., JINHUA (CN)

(72) Inventor: XIAONENG HU, YONGKANG (CN)

(21) Appl. No.: 18/744,922

(22) Filed: Jun. 17, 2024

(30) Foreign Application Priority Data
May 23, 2024 (CN) 202410648298.0

(51) Int. Cl. A61G 5/04

(52) U.S. Cl. CPC A61G 5/04; A61G 2203/20; A61G 2203/34

(57) ABSTRACT

Provided is a walking aid device, including a wheelchair, a drive control module, a front control module, and a rear control module. The drive control module is disposed on the wheelchair for driving same to move. The front control module is connected to the drive control module for outputting a first control signal. The drive control module responds to the first control signal and thus controls the wheelchair to move at a corresponding speed. The rear control module is connected to the drive control module for outputting second and third control signals. The drive control module responds to the second and third control signals to respectively control the wheelchair to provide corresponding propulsion assistance/resistance or corresponding support resistance. The walking aid device includes the front control module and the rear control module, which are configured to achieve better human-machine interaction, making a user better control the wheelchair.

### TECHNICAL FIELD

The present disclosure relates to the technical field of rehabilitation equipment, and in particular to a walking aid device.

### BACKGROUND

Wheelchairs are important tools for rehabilitation. They are not only a means of transportation for physically disabled individuals with limited mobility, but more importantly, they enable them to do physical exercise and participate in social activities with the help of wheelchairs.

Wheelchairs have evolved from the original hand-propelled wheelchairs to electric wheelchairs, and in recent years, more intelligent smart walking aid devices have emerged. However, the technology for the walking aid device is complex and costly, especially in terms of human-machine interaction, which has not been well solved, making this technology still far from practicality.

### SUMMARY

The purpose of the present disclosure is to provide a walking aid device, so as to solve the problem that the human-machine interaction intelligence level of the existing walking aid device is lower.

In order to achieve the above purpose, the present disclosure provides a walking aid device, including:
a wheelchair;
a drive control module, disposed on the wheelchair for driving same to move;
a front control module, connected to the drive control module for outputting
a first control signal, the drive control module responding to the first control signal and thus controlling the wheelchair to move at a corresponding speed; and
a rear control module, connected to the drive control module for outputting a second control signal and a third control signal, the drive control module responding to the second control signal and the third control signal to respectively control the wheelchair to provide corresponding propulsion assistance/resistance or provide corresponding support resistance.

Optionally, the front control module is automatically connected to the drive control module after being started, and the rear control module is automatically connected to the drive control module after being started; and in a case that both the front control module and the rear control module are started, the connection between the front control module and the drive control module is preferentially established.

Optionally, after the connection between the rear control module and the drive control module is established, if the front control module is connected to the drive control module, the connection between the rear control module and the drive control module automatically fails.

Optionally, the front control module is provided with a first switch interaction unit, a first gear position interaction unit and a first direction switching unit, and the front control module is controlled to start or stop by the first switch interaction unit; the moving speed of the wheelchair is switched by way of the first gear position interaction unit; and a moving direction of the wheelchair is switched by way of the first direction switching unit.

Optionally, the rear control module is provided with a pressure detector, and the pressure detector is disposed on a grip behind a backrest of the wheelchair; the pressure detector is configured to detect whether the grip is held, and to send a detection result to the rear control module; and the rear control module allows outputting the second control signal in a case that determining that the grip is held according to the detection result.

Optionally, in a case that the rear control module determines that the grip has not been held for more than a predetermined time according to the detection result, a function of the rear control module to output the second control signal is locked, and thus the wheelchair is locked; and in a case that the rear control module determines that the grip is held, unlocking is performed.

Optionally, the rear control module is provided with a second switch interaction unit, a propulsion mode enable unit, a support mode enable unit, a second gear position interaction unit and a second direction switching unit, and the rear control module is controlled to start or stop by the second switch interaction unit; the wheelchair is controlled to provide the propulsion assistance/resistance by way of the propulsion mode enable unit; the wheelchair is controlled to provide the support resistance by way of the support mode enable unit; the second gear position interaction unit is used for switching a magnitude of the propulsion assistance/resistance or the support resistance provided by the wheelchair; and the moving direction of the wheelchair is switched by way of the second direction switching unit.

Optionally, the wheelchair has a constant speed propulsion assistance mode and an automatic propulsion assistance/resistance mode; in the constant speed propulsion assistance mode, the wheelchair moves in a predetermined direction at a predetermined speed; and in the automatic propulsion assistance/resistance mode, the wheelchair provides forward propulsion assistance in a case that moving forward, provides backward propulsion assistance in a case that moving backward, generates the propulsion resistance in a case that going downhill, and increases the propulsion assistance in a case that going uphill.

Optionally, the wheelchair is provided with a brake handle, and in a case that the brake handle is held, the drive control module controls the wheelchair to brake.

Optionally, the front control module is disposed on an armrest of the wheelchair, and the rear control module is disposed on a grip behind a backrest of the wheelchair.

The walking aid device provided by the present disclosure includes the wheelchair, the drive control module, the front control module, and the rear control module. The drive control module is disposed on the wheelchair for driving same to move; the front control module is connected to the drive control module for outputting the first control signal, and the drive control module responds to the first control signal and thus controls the wheelchair to move at the corresponding speed; the rear control module is connected to the drive control module for outputting the second and third control signals; and the drive control module responds to the second and third control signal to respectively control the wheelchair to provide the corresponding propulsion assistance/resistance or provide the corresponding support resistance. The walking aid device provided by the present disclosure includes the front control module and the rear control module, which are configured to achieve better human-machine interaction, making a user better control the wheelchair.

### BRIEF DESCRIPTION OF FIGURES

FIG. 1 is a schematic structural diagram of a walking aid device provided in an embodiment of the present disclosure;

FIG. 2 is another schematic structural diagram of a walking aid device provided in an embodiment of the present disclosure;

FIG. 3 is a schematic structural diagram of a front control module provided in an embodiment of the present disclosure; and

FIG. 4 is a schematic structural diagram of a rear control module provided in an embodiment of the present disclosure.

The following reference numerals on the drawings are described below:
10 denotes a wheelchair; 101 denotes armrests; 102 denotes grips; 20 denotes a drive control module; 30 denotes a front control module; 31 denotes a first on-off button; 32 denotes an acceleration button; 33 denotes a deceleration button; 34 denotes a first switching button; 40 denotes a rear control module; 41 denotes a second on-off button; 42 denotes a propulsion mode enable button; 43 denotes a support mode enable button; 44 denotes a gear position switching button; and 45 denotes a second switching button.

### DETAILED DESCRIPTION

Specific embodiments of the present disclosure will be described in more detail below in conjunction with the schematic diagram. The advantages and features of the present disclosure will become more apparent from the following description. It should be noted that all the accompanying drawings are in a very simplified form and use imprecise proportions, which are only used to conveniently and clearly assist in illustrating the purpose of the embodiments of the present disclosure.

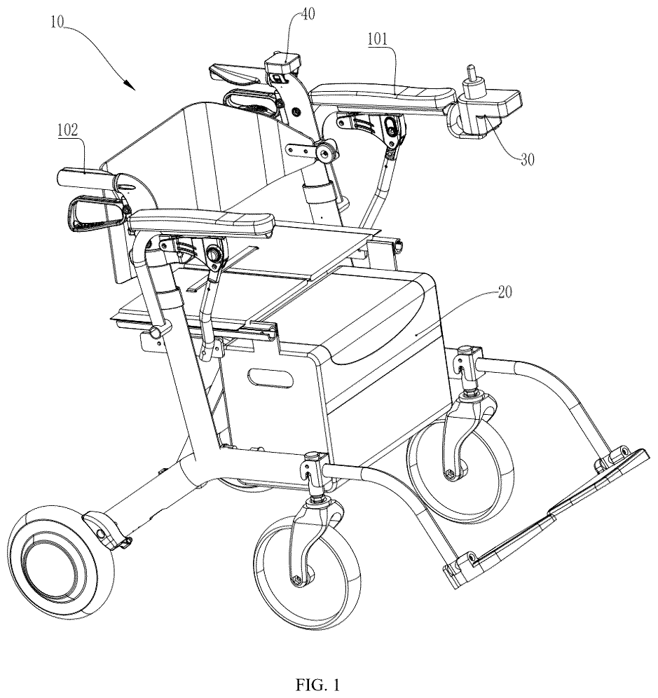

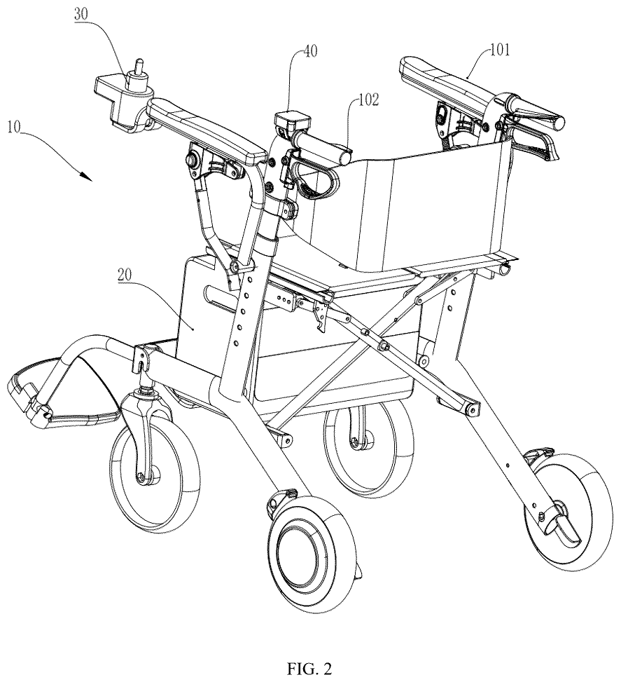

FIG. 1 and FIG. 2 are both schematic structural diagrams of a walking aid device provided in an embodiment of the present disclosure. As shown in FIG. 1 and FIG. 2, the walking aid device includes a wheelchair 10, a drive control module 20, a front control module 30, and a rear control module 40.

Specifically, the wheelchair 10 includes a frame, wheels, a seat cushion, a backrest, armrests 101, grips 102, foot rests, and other structures. Since the structure of the wheelchair 10 is not the focus of the present disclosure, it will not be further elaborated herein.

The drive control module 20 is disposed on the wheelchair 10 for driving the wheelchair 10 to move. In this embodiment, the drive control module 20 is disposed under the seat cushion of the wheelchair 10 and is fixed on the frame, but should not be limited thereto. The drive control module 20 may be disposed at any of other suitable positions of the wheelchair 10. The drive control module 20 may include a battery system, a motor system, a central control system that controls the operation of the battery system and the motor system, and the like, which will not be illustrated one by one herein.

The front control module 30 is connected to the drive control module 20 for outputting a first control signal. In a case that receiving the first control signal, the drive control module 20 may control the wheelchair 10 to move at a corresponding speed in response to the first control signal. The front control module 30 and the drive control module 20 may be in a wired or wireless connection, as long as communication between the front control module 30 and the drive control module 20 can be achieved.

In this embodiment, the front control module 30 may be disposed on any of the armrests 101 of the wheelchair 10 (preferably on the left-hand armrest 101), which is convenient for a person sitting on the wheelchair 10 to operate, but should not be limited thereto. The front control module 30 may also be disposed at any of other suitable positions of the wheelchair 10.

Similarly, the rear control module 40 is connected to the drive control module 20 for outputting a second control signal and a third control signal. In a case that receiving the second control signal and the third control signal, the drive control module 20 may respectively control the wheelchair 10 to provide corresponding propulsion assistance/resistance or provide corresponding support resistance in response to the second control signal and the third control signal. The rear control module 40 and the drive control module 20 may be in a wired or wireless connection, as long as communication between the rear control module 40 and the drive control module 20 can be achieved.

In this embodiment, the rear control module 40 may be disposed on any of the grips 102 behind a backrest of the wheelchair 10 (preferably on the left-hand grip 102), which is convenient for a person pushing the wheelchair 10 to operate, but should not be limited thereto. The rear control module 40 may also be disposed at any of other suitable positions of the wheelchair 10.

Further, the front control module 30 is automatically connected to the drive control module 20 after being started (which is a communication connection), and the rear control module 40 is automatically connected to the drive control module 20 after being started (which is a communication connection); and in a case that both the front control module 30 and the rear control module 40 are started (for example, started at the same time), the connection between the front control module 30 and the drive control module 20 is preferentially established. After the connection between the rear control module 40 and the drive control module 20 is established, if the front control module 30 is connected to the drive control module 20, the connection between the rear control module 40 and the drive control module 20 automatically fails. That is to say, the front control module 30 and the rear control module 40 cannot control the walking aid device at the same time, thus avoiding the occurrence of dangerous situations caused by the control disorder of the walking aid device. Moreover, compared with the rear control module 40, the front control module 30 has the priority of controlling the walking aid device; and since the front control module 30 is suitable for the operation of a person sitting on the wheelchair 10, while the rear control module 40 is suitable for the operation of a person pushing the wheelchair 10, it is more reasonable to design the control priority of the front control module 30 to be higher.

In this embodiment, the front control module 30 is provided with a first switch interaction unit, a first gear position interaction unit and a first direction switching unit, and the front control module 30 is controlled to start or stop by the first switch interaction unit; the moving speed of the wheelchair 10 is switched by way of the first gear position interaction unit; and a moving direction of the wheelchair 10 is switched by way of the first direction switching unit.

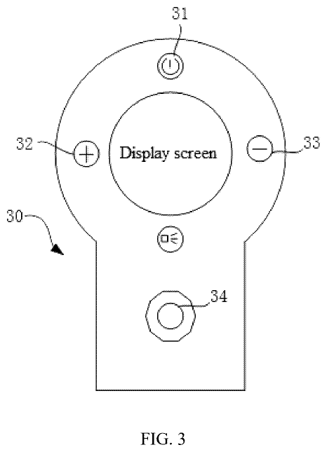

FIG. 3 is a schematic structural diagram of the front control module 30 provided in an embodiment of the present disclosure. As shown in FIG. 3, the first switch interaction unit, the first gear position interaction unit and the first direction switching unit may all be buttons, or may all be touch screens, or may be a combination of buttons and touch screens. For example, the first switch interaction unit includes a first on-off button 31. If the first on-off button 31 is pressed for a short time, the front control module 30 is started, and if the first on-off button 31 is pressed for a long time, the front control module 30 is turned off. The first gear position interaction unit includes an acceleration button 32 and a deceleration button 33. In a case that the acceleration button 32 is pressed, the front control module 30 sends the first control signal correspondingly, and the drive control module 20 controls the wheelchair 10 to move at a predetermined speed according to the first control signal. If the acceleration button 32 is pressed again, the front control module 30 sends first control signal correspondingly, and the drive control module 20 controls the wheelchair 10 to move at the predetermined speed plus a fixed value according to the first control signal. If the deceleration button 33 is then pressed, the front control module 30 sends the first control signal correspondingly, and the drive control module 20 controls the wheelchair 10 to move at the predetermined speed minus the fixed value according to the first control signal. The first direction switching unit may include a first switching button 34. If the first switching button 34 is pressed, the drive control module 20 can switch the moving direction (forward or backward) of the wheelchair 10.

In this embodiment, the first gear position interaction unit may control the wheelchair 10 to move at a speed of 1-5 gears. The higher the gear, the faster the speed. The wheelchair 10 may move forward at a speed of 1.2-6 km/h, and the wheelchair 10 may move backward at a speed of 1-2.2 km/h. The front control module 30 may also be provided with structures such as a horn button and a display screen, which are configured to achieve the functions such as honking, and displaying a current gear position, a switch state, and the moving direction.

Further, the rear control module 40 is provided with a pressure detector (not shown in FIG. 1 to FIG. 4), and the pressure detector may be disposed on the grip 102 behind the backrest of the wheelchair 10. The pressure detector is configured to detect whether the grip 102 is held, and to send a detection result to the rear control module 40. The rear control module 40 allows outputting the second control signal in a case that determining that the grip 102 is held according to the detection result, which prevents misoperation and improves the safety performance of the walking aid device. In this embodiment, in a case that the rear control module 40 determines that the grip 102 has not been held for more than a predetermined time according to the detection result, the function of the rear control module 40 to output the second control signal is locked, and thus the wheelchair 10 is locked; and in a case that the rear control module 40 determines that the grip 102 is held, unlocking may be performed.

The rear control module 40 is provided with a second switch interaction unit, a propulsion mode enable unit, a support mode enable unit, a second gear position interaction unit and a second direction switching unit, and the rear control module 40 is controlled to start or stop by the second switch interaction unit; the wheelchair 10 is controlled to provide the propulsion assistance/resistance by way of the propulsion mode enable unit; the wheelchair 10 is controlled to provide the support resistance by way of the support mode enable unit; the second gear position interaction unit is used for switching a magnitude of the propulsion assistance/resistance or the support resistance provided by the wheelchair 10; and the moving direction of the wheelchair 10 is switched by way of the second direction switching unit.

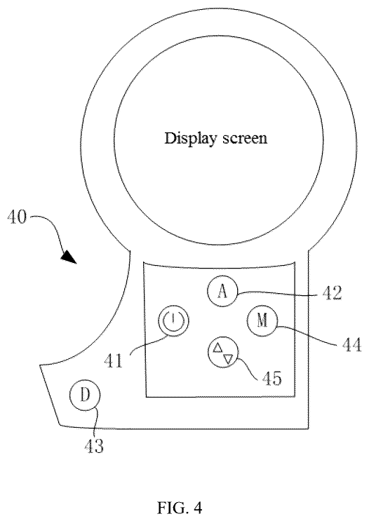

FIG. 4 is a schematic structural diagram of the rear control module 40 provided in an embodiment of the present disclosure. As shown in FIG. 4, the second switch interaction unit, the propulsion mode enable unit, the support mode enable unit, the second gear position interaction unit and the second direction switching unit may all be buttons, or may all be touch screens, or may be a combination of buttons and touch screens. For example, the second switch interaction unit includes a second on-off button 41. If the second on-off button 41 is pressed for a short time, the rear control module 40 is started, and if the second on-off button 41 is pressed for a long time, the rear control module 40 is turned off. The propulsion mode enable unit includes a propulsion mode enable button 42. If the propulsion mode enable button 42 is pressed, the rear control module 40 outputs the second control signal, and the drive control module 20 controls the wheelchair 10 to provide the propulsion assistance/resistance. The support mode enable unit includes a support mode enable button 43. If the support mode enable button 43 is pressed, the rear control module 40 outputs the third control signal, and the drive control module 20 controls the wheelchair 10 to provide the support resistance. The second gear position interaction unit includes a gear position switching button 44. If the gear position switching button 44 is pressed, the rear control module 40 sends the corresponding second control signal or third control signal, so as to switch the magnitude of the propulsion assistance/resistance or the support resistance provided by the wheelchair 10. The second direction switching unit includes a second switching button 45. If the second switching button 45 is pressed, the drive control module 20 can switch the moving direction (forward or backward) of the wheelchair 10.

In this embodiment, the second gear position interaction unit may control wheelchair 10 to provide support resistance of 1-3 gears. The higher the gear, the smaller the resistance. The rear control module 40 may also be provided with structures such as a horn button and a display screen, which are configured to achieve the functions such as honking, and displaying a current gear position, a switch state, and the moving direction.

Further, the wheelchair 10 has a constant speed propulsion assistance mode and an automatic propulsion assistance/resistance mode; and the constant speed propulsion assistance mode and the automatic propulsion assistance/resistance mode can be switched by way of the propulsion mode enable button 42 (or by adding other buttons). In the constant speed propulsion assistance mode, the wheelchair 10 moves in a predetermined direction (usually forward) at a predetermined speed, so as to provide the propulsion assistance; and in the automatic propulsion assistance/resistance mode, the wheelchair 10 provides forward propulsion assistance in a case that moving forward, provides backward propulsion assistance in a case that moving backward, generates the propulsion resistance in a case that going downhill, and increases the propulsion assistance in a case that going uphill.

It should be noted that the buttons on the front control module 30 and the rear control module 40 are only examples and are not limited thereto. As long as the front control module 30 can output the first control signal to control the wheelchair 10 to move at the corresponding speed, and the rear control module 40 can output the second control signal and the third control signal to respectively control the wheelchair 10 to provide the corresponding propulsion assistance/resistance or provide the corresponding support resistance, the content of the present disclosure can be achieved.

In this embodiment, the wheelchair 10 is provided with a brake handle; and in a case that the brake handle is held, the drive control module 20 controls the wheelchair 10 to brake, achieving emergency braking and improving safety performance.

In summary, the walking aid device provided by the embodiments of the present disclosure includes the wheelchair 10, the drive control module 20, the front control module 30, and the rear control module 40. The drive control module 20 is disposed on the wheelchair 10 for driving the wheelchair 10 to move; the front control module 30 is connected to the drive control module 20 for outputting the first control signal, and the drive control module 20 responds to the first control signal and thus controls the wheelchair 10 to move at the corresponding speed; the rear control module 40 is connected to the drive control module 20 for outputting the second and third control signals, and the drive control module 20 responds to the second and third control signals to respectively control the wheelchair 10 to provide the corresponding propulsion assistance/resistance or provide the corresponding support resistance. The walking aid device provided by the present disclosure includes the front control module 30 and the rear control module 40. The front control module 30 and the rear control module 40 are configured to achieve better human-machine interaction, making a user better control the wheelchair 10.

It should be noted that all embodiments provided in this Description are described in a progressive manner, each of the embodiments focuses on the differences from the other embodiments, and the same and similar parts between the embodiments can be referred to each other. With respect to systems disclosed in the embodiments, the descriptions of the systems are relatively simple as they correspond to the methods disclosed in the embodiments and the relevant information can be referred to the section of the methods.

It should also be noted that although the present disclosure has been disclosed as above in exemplary embodiments, the above embodiments are not intended to limit the present disclosure. For anyone skilled in the art, without departing from the scope of the technical solutions of the present disclosure, the technical content disclosed above can be used to make many possible changes and modifications to the technical solutions of the present disclosure, or to modify the technical solutions of the present disclosure into equivalent embodiments of equivalent changes. Therefore, any simple amendments, equivalent changes, and modifications made to the above embodiments according to the technical essence of the present disclosure without departing from the content of the technical solutions of the present disclosure still fall within the scope of protection of the technical solutions of the present disclosure.

It should also be understood that, unless otherwise specified or pointed out, the terms “first”, “second”, “third” and other descriptions in the Description are merely used to distinguish the various components, elements, steps, and the like therein, rather than to represent the logical or sequential relationships between the components, elements, steps, and the like.

Furthermore, it should also be recognized that the terms described herein are only used to describe specific embodiments, and are not intended to limit the scope of the present disclosure. It must be noted that, as used herein and in the appended claims, the singular forms “one” and “a” include plural references unless the context explicitly suggests otherwise. For example, a reference to “a step” or “a device” implies a reference to one or more steps or devices, and may include sub-steps as well as sub-devices. All conjunctions used should be understood in their broadest sense. And, the word “or” should be understood as having a logical “or” definition, rather than a logical “exclusive or” definition, unless the context explicitly suggests otherwise. In addition, implementation of the methods and/or apparatus in the embodiments of the present disclosure may include performing the selected tasks manually, automatically, or in combination.

What is claimed is:

1. A walking aid device, comprising:
a wheelchair;
a drive control module, disposed on the wheelchair for driving same to move;
a front control module, connected to the drive control module for outputting a first control signal, the drive control module responding to the first control signal and thus controlling the wheelchair to move at a corresponding speed; and
a rear control module, connected to the drive control module for outputting a second control signal and a third control signal, the drive control module responding to the second control signal and the third control signal to respectively control the wheelchair to provide corresponding propulsion assistance/resistance or provide corresponding support resistance.

2. The walking aid device according to claim 1, wherein the front control module is automatically connected to the drive control module after being started, and the rear control module is automatically connected to the drive control module after being started; and in a case that both the front control module and the rear control module are started, the connection between the front control module and the drive control module is preferentially established.

3. The walking aid device according to claim 2, wherein after the connection between the rear control module and the drive control module is established, if the front control module is connected to the drive control module, the connection between the rear control module and the drive control module automatically fails.

4. The walking aid device according to claim 3, wherein the front control module is provided with a first switch interaction unit, a first gear position interaction unit and a first direction switching unit, and the front control module is controlled to start or stop by the first switch interaction unit; the moving speed of the wheelchair is switched by way of the first gear position interaction unit; and a moving direction of the wheelchair is switched by way of the first direction switching unit.

5. The walking aid device according to claim 3, wherein the rear control module is provided with a pressure detector, and the pressure detector is disposed on a grip behind a backrest of the wheelchair; the pressure detector is configured to detect whether the grip is held, and to send a detection result to the rear control module; and the rear control module allows outputting the second control signal in a case that determining that the grip is held according to the detection result.

6. The walking aid device according to claim 5, wherein in a case that the rear control module determines that the grip has not been held for more than a predetermined time according to the detection result, a function of the rear control module to output the second control signal is locked, and thus the wheelchair is locked; and in a case that the rear control module determines that the grip is held, unlocking is performed.

7. The walking aid device according to claim 3, wherein the rear control module is provided with a second switch interaction unit, a propulsion mode enable unit, a support mode enable unit, a second gear position interaction unit and a second direction switching unit, and the rear control module is controlled to start or stop by the second switch interaction unit; the wheelchair is controlled to provide the propulsion assistance/resistance by way of the propulsion mode enable unit; the wheelchair is controlled to provide the support resistance by way of the support mode enable unit; the second gear position interaction unit is used for switching a magnitude of the propulsion assistance/resistance or the support resistance provided by the wheelchair; and a moving direction of the wheelchair is switched by way of the second direction switching unit.

8. The walking aid device according to claim 7, wherein the wheelchair has a constant speed propulsion assistance mode and an automatic propulsion assistance/resistance mode; in the constant speed propulsion assistance mode, the wheelchair moves in a predetermined direction at a predetermined speed; and in the automatic propulsion assistance/resistance mode, the wheelchair provides forward propulsion assistance in a case that moving forward, provides backward propulsion assistance in a case that moving backward, generates the propulsion resistance in a case that going downhill, and increases the propulsion assistance in a case that going uphill.

9. The walking aid device according to claim 1, wherein the wheelchair is provided with a brake handle, and in a case that the brake handle is held, the drive control module controls the wheelchair to brake.

10. The walking aid device according to claim 1, wherein the front control module is disposed on an armrest of the wheelchair, and the rear control module is disposed on a grip behind a backrest of the wheelchair.
